(19) United States
(12) Patent Application Publication
(10) Pub. No.: US 2024/0351466 A1
(43) Pub. Date: Oct. 24, 2024

(54) Adapting Charging Operations of Electric Vehicles

(71) Applicant: Bayerische Motoren Werke AKtiengesellschaft, Muenchen (DE)

(72) Inventor: Enrique MARCIAL-SIMON, Veitshoechheim (DE)

(21) Appl. No.: 18/294,209

(22) PCT Filed: Jul. 26, 2022
(86) PCT No.: PCT/EP2022/070918

§ 371 Date: Feb. 1, 2024

(30) Foreign Application Priority Data
Aug. 2, 2021 (DE) 10 2021 119 966.2

(51) Int. Cl. B60L 53/65; B60L 53/63; B60L 53/67; B60L 53/68

(52) U.S. Cl. CPC B60L 53/65; B60L 53/63; B60L 53/67; B60L 53/68

(57) ABSTRACT

A method adapting charging operations of electric vehicles, in which method a fleet operator of a fleet of electric vehicles receives power request information from an operator of a first power supply network; electric vehicles of the fleet, which are currently being charged, are located in the vicinity of the first power supply network and are not uniquely assigned to a charging station, are assigned a probability that they are being charged from the first power supply network; on the basis of these probabilities the electric vehicles are classified as being charged from the first power supply network or as not being charged from the first power supply network; and the charging operations of the electric vehicles classified as being charged from the first power supply network are adapted on the basis of the received power request information.

### BACKGROUND AND SUMMARY

The invention relates to a method for adapting charging operations of electric vehicles, wherein a fleet operator of a fleet of electric vehicles receives power request information from an operator of a first power supply network. The invention also relates to a charging control system configured to carry out the method. The invention furthermore relates to a computer program product comprising code which, when it is executed on a data processing device of the charging control system, causes the method to be implemented.

Energy storage devices, in particular batteries, of electric vehicles (e.g., plug-in hybrid vehicles or fully electrically operated vehicles) are charged at charging stations, each of which is assigned to a power supply network of a specific operator or power supplier. In this case, the charging operations may be influenced by a large number of influencing variables, e.g., by a quantity of power provided by the power supplier, a capacity utilization of the power supply network, agreed charging conditions between the user of the electric vehicle and the manufacturer of the electric vehicle, etc. If it is known which electric vehicles having which charging properties are connected to which charging stations, the charging behavior thereof can be adapted to the present requirements of the power supply network and the power supply network can be better balanced as a result. Such power supply management is known in principle.

By way of example, if the quantity of power available in a specific power supply network is currently limited, the operator of the power supply network may communicate, to fleet operators of fleets of electric vehicles that cooperate with the operator, power request information to the effect that the power consumption of electric vehicles currently being charged from this power supply network ought to be lowered. The fleet operators may then adapt the charging operations of these electric vehicles being charged to the power request information under remote control (e.g., by communication of corresponding SMS messages), e.g., may reduce the charging power, terminate charging operations early, etc.

The knowledge of which electric vehicle is connected to a charging station of the power supply network under consideration may arise as a result of data exchange between the charging partners, i.e., the charging station and the electric vehicle, as a result of transfer of data that are uniquely identifiable in respect of the electric vehicle, such as the latter's VIN, e.g., according to ISO 15118, or a “fingerprint” of charging features of the electric vehicle. These data and also the fact that a specific electric vehicle is currently being charged may be transferred from the electric vehicle to an associated fleet operator, e.g., via radio. Therefore, the fleet operator then knows unambiguously whether this electric vehicle is drawing its charging current from the power supply network from which the fleet operator obtained power request information.

DE 10 2015 210 726 A1 discloses a method for ascertaining a charging pair comprising a charging partner from each of two different sets of possible charging partners. The two different sets comprise a set of possible charging stations and a set of possible vehicles. The charging pair comprises a charging station and a vehicle that carries out a charging operation at the charging station. The method comprises instigating a stimulus in relation to the charging operation by means of a stimulating charging partner from a first set of the two sets of possible charging partners. Moreover, the method comprises detecting a reaction to the stimulus by means of a reacting charging partner from a second set of the two sets of possible charging partners. Furthermore, the method comprises forming a charging pair comprising the stimulating charging partner and the reacting charging partner.

DE 10 2016 212 245 A1 is directed to a method for operating a charging station which makes it possible to supply an electrically operated vehicle with the maximum charging power only after a positive identification, is directed to a method for planning an electrical charging operation of a vehicle which is electrically coupled to a charging station by means of a charging cable.

DE 10 2016 212 244 A1 is directed to a method for planning an electrical charging operation of a vehicle which is electrically coupled to a charging station by means of a charging cable.

DE 10 2018 212 283 A1 discloses a method for ascertaining a charging pair comprising a charging partner from each of two different sets of possible charging partners, wherein the two different sets comprise a set of possible charging stations and a set of possible hybrid or electric vehicles, wherein the charging pair comprises a charging station and a hybrid or electric vehicle that carries out a charging operation at the charging station. The method comprises determining at least one temporal reaction property of at least one possible charging partner from the possible charging partners; instigating a stimulus in relation to the charging operation by means of a stimulating charging partner from a first set of the two sets of possible charging partners, wherein the stimulus is instigated on the basis of the at least one temporal reaction property; detecting a reaction to the stimulus by means of a reacting charging partner from a second set of the two sets of possible charging partners; and forming a charging pair comprising the stimulating charging partner and the reacting charging partner, on the basis of the detected reaction.

An electric vehicle may also be uniquely identifiable by a unique spatial correlation (“1-to-1 assignment”) of its vehicle position with the position of a charging station. This is the case, for example, if the position of the electric vehicle, given high accuracy of the position determining device (e.g., of ±1 m), corresponds to the charging station's position, which is likewise known with high accuracy, if appropriate with the further knowledge that no further electric vehicle is located in the vicinity of the charging station.

However, a problem occurs if the fleet operator knows that an electric vehicle of the operator's fleet is being charged at a charging station in the vicinity of the power supply network under consideration, but the charging station cannot be uniquely identified. This situation may be present, for example, if the charging partners do not exchange data uniquely identifying them and the position of the electric vehicle is known only inaccurately (e.g., within a radius of 10 m, for example, owing to an inaccurate locating technology used or as a result of the presence of buildings, mountains, etc.) and/or charging stations, in particular also of different power suppliers, are situated close together and/or their position is not accurately known.

The object of the present invention is at least partly to overcome the disadvantages of the prior art and in particular to provide an improved possibility for a fleet operator, upon request by an operator of a power supply network, to adapt charging operations of electric vehicles being charged at charging stations of this power supply network to the request.

This object is achieved in accordance with the features of the independent claims. Preferred embodiments can be gathered from the dependent claims, in particular.

The object is achieved by means of a method for adapting charging operations of electric vehicles, wherein a fleet operator of a fleet of electric vehicles
receives power request information from an operator of a power supply network (referred to as “first” power supply network hereinafter without restricting the generality);
assigns to electric vehicles of the fleet which are currently being charged and which are located in the vicinity of the first power supply network or at least one charging station thereof and are not uniquely assigned or assignable to a charging station a probability that they are currently being charged from the first power supply network or are connected to at least one charging station thereof;
on the basis of these probabilities, classifies the electric vehicles as being charged from the first power supply network or not being charged from the first power supply network, and
adapts the charging operations of the electric vehicles classified as being charged from the first power supply network or connected to the first power supply network on the basis of the received power request information.

This achieves the advantage that even if a unique 1-to-1 assignment between an electric vehicle being charged and a charging station of the first power supply network is not able to be established, the fleet operator can nevertheless include this electric vehicle in the operator's charging strategy for the first power supply network. This in turn improves the balancing of the first power supply network.

This presupposes that the electric vehicles located in the vicinity of the first power supply network can be remotely identified individually, e.g., by means of radio communication or radio retrieval of their VIN. If an electric vehicle is individually identifiable, typically its charging properties are known as well, for example, vehicle-inherent charging features such as a capacity of the energy storage device, a charging rate, an age of the energy storage device, etc., and optionally also contractually negotiated charging conditions such as the right to full or only partial charging. Moreover, from the remotely identifiable electric vehicle, its geo-position and its charging status (e.g., charging/not charging) are transferable to the fleet operator. This vehicle information can be communicated automatically from the electric vehicle to the fleet operator (“push”), e.g., at regular time intervals or in an event-controlled manner, e.g., at the beginning of a charging operation. Alternatively or additionally, the vehicle information can be remotely retrieved by the fleet operator (“pull”).

The electric vehicle can be, e.g., an automobile, a truck, a bus, a motorcycle, etc.

The fleet operator can be a manufacturer of electric vehicles or can operate electric vehicles from different manufacturers. The fleet operator can in particular run a charging control system in order to carry out the method. The charging control system is configured in particular to adapt the charging operations on the basis of a charging strategy based on power supply management.

Power request information can comprise a present or predicted status of the first power supply network which could influence charging operations of electric vehicles, e.g., an available quantity of electrical energy or power or changes thereof. By way of example, a reduction of the quantity of power available in the first power supply network can occur as a result of an outage of power generating units (power plants, solar installations, etc.), the outage of power lines, an increased power consumption of other consumers in the power supply network, etc., including for a short period. The power request information can then comprise, e.g., a request to reduce the utilized charging power of electric vehicles being charged for a short period. By means of remote-controlled adaptation of the charging operations of electric vehicles currently being charged, the fleet operator will then attempt to comply with this request, specifically so that the users of the electric vehicles being charged are adversely affected by this as little as possible.

In particular, the following electric vehicles currently being charged can be uniquely assigned to the first power supply network by the fleet operator:
all electric vehicles which are in a 1-to-1 relationship with a charging station of the first power supply network;
all electric vehicles which are uniquely located within the geographical extent or area of the first power supply network, even if they have not established a 1-to-1 relationship with a charging station.

On the other hand, an electric vehicle “in the vicinity” of the first power supply network can be understood to mean an electric vehicle which could be connected to the first power supply network or to a neighboring (“second”) power supply network from the viewpoint of the fleet operator taking into account the positional inaccuracies of the electric vehicle and/or the charging station. The circumstance that an electric vehicle currently being charged is not uniquely assignable to a charging station encompasses the circumstance in particular that the fleet operator knows that the electric vehicle is being charged, but cannot unambiguously determine whether the electric vehicle is being charged from a charging station of the first power supply network or from a charging station of the neighboring second power supply network.

The operator of the first power supply network and the operator of the second power supply network can be different operators or the same operator. Particularly if the operator is the same operator, the first power supply network and the second power supply network can be subnetworks or partial networks of a superordinate power supply network.

Uncertainties regarding the position of the electric vehicle and/or a charging station can be caused, for example, by one or more of the following reasons:
the position determining device or the locating technology used in the electric vehicles outputs only comparatively inaccurate positions;
the position determination is subject to uncertainties that are caused geographically, e.g., as a result of tall buildings on a street, mountains, etc.;
the position of the charging station has not been detected accurately. In this regard, the scenario is conceivable, for example, in which specific buildings on a street are equipped with charging stations (e.g., with corresponding Schuko connectors), but the power supplier does not know the position of the Schuko connectors on the buildings or does not even know at which buildings on the street a charging station is located. An added complicating factor may be that one side of the street is supplied from the first power supply network (or “grid”), while the other side is supplied from a second power supply network.

The charging stations can be dedicated charging stations. The charging stations can also be Schuko connectors or other domestic connectors, e.g., wallboxes. In one development, a power supply network can have a plurality of charging stations which cannot be differentiated electrically or in terms of charging technology by the power supply network, e.g., because they are connected to the same electricity distributor or electricity meter.

In one development, the position and optionally the associated positional accuracy of a specific electric vehicle are determined by means of a position determining device of this electric vehicle, e.g., on the basis of GPS, GLONASS, WLAN, etc. The positional accuracy can be dependent on the position determining device installed in the electric vehicle (e.g., more accurate or less accurate GPS) and/or the locating technology used by the electric vehicle (e.g., GPS, WLAN, etc.). In one development, the position determining device of the electric vehicle and/or the locating technology thereof can likewise be interrogated by remote identification.

It is also possible for typical positional accuracies for specific regions of a power supply network to be previously known or predefined. Such positional accuracies can have been ascertained representatively by means of experiments or measurements, for example.

From the positional (in)accuracies of the electric vehicles and the at least one charging station in the vicinity of the respective electric vehicles and/or optionally further information such as a length of a charging cable, etc., for example, it is possible to determine probabilities for the electric vehicles that they are connected to a charging station of the first power supply network for charging purposes. With knowledge of at least these probabilities, the fleet operator can determine or establish which electric vehicles are assumed to be connected to the first power supply network, and the fleet operator can adapt the charging operations of these electric vehicles to the received power request information and thus to the operator's charging strategy, if possible and/or practical. The fleet operator may then more likely tend to assign e.g. electric vehicles to a charging station of the first power supply network, the higher the probabilities thereof.

In one configuration, an electric vehicle is assigned probability values that it is connected to a specific charging station of the first power supply network, the probability values being dependent at least on an ascertained distance between the electric vehicle and this charging station. In other words, a specific electric vehicle is assigned a correlation between a probability of connection to a charging station of the power supply network in the vicinity of the electric vehicle depending on the distance from the charging station. The probability values can be determined or can have been determined e.g. experimentally, on the basis of empirical values and/or as a result of simulations.

The probability values can be plotted as a distance-dependent curve. The probability values can be present, e.g., stored, e.g., as a table, a characteristic curve, etc.

In one configuration, a probability value is all the greater, the smaller the distance between the electric vehicle and the charging station.

In one configuration, the probability values are dependent on a position determining device and/or locating technology used by the relevant electric vehicle, or the accuracy/accuracies thereof. The probability values can be determined more realistically as a result. The probability values are then typically vehicle-dependent or -inherent and dependent, e.g., on the type and/or the equipment of the remotely identifiable electrically operated electric vehicle. In one variant, electric vehicles having the same position determining device and/or locating technology can be assigned identical probability values.

In one configuration, the probability values are dependent on an accuracy of the knowledge of the position of the at least one charging station. By this means, too, it is possible to improve the knowledge about the probability of connection of a specific electric vehicle to a charging station. As already indicated above, this position may be known comparatively accurately or else only very inaccurately, in the latter case, e.g., only within a housing width or a length of a street, in a high housing gully, etc.

In one development, consideration is given only to such charging stations for which a specific minimum probability is present, e.g., of at least one percent or 5%. On the other hand, in one development, a 1-to-1 assignment can be assumed if the probability reaches or exceeds an upper probability threshold value, e.g., of 98% or 990%.

In one development, consideration is given only to such charging stations having a distance within a predefined maximum distance. This maximum distance can be, e.g., approximately 10 m and can thus encompass customary lengths of charging cables.

In one configuration, the probability that an electric vehicle is connected to a charging station of a power supply network is dependent on the number of charging stations of the first power supply network which are located in the vicinity. This configuration is particularly advantageous for the case where the operator or electricity supplier is not able to differentiate to which charging station in a group of charging stations of the power supply network the electric vehicle is connected, e.g., because a plurality of charging stations are supplied with electricity via the same electricity distributor. Such a scenario may be present for example if, on a street, a plurality of charging stations, e.g., Schuko connectors, are connected to a common electricity distributor via a common electricity supply line and there is no further possibility for the operator of the power supply network to assign the connection of an electric vehicle to a specific charging station of these charging stations. The greater the number of such charging stations to which an electric vehicle could be connected, the higher, in one development, the probability that the electric vehicle could be connected to one of these possible charging stations tends to become. The charging stations to which the electric vehicle can or could be connected can exclude such charging stations to which another electric vehicle is definitely connected. The probability that an electric vehicle is connected to any charging station of the first power supply network can be calculated for example by a correlation or “cumulation” of the individual probabilities of a possible connection to the charging station respectively considered.

In one development, charging stations of another, second power supply network in the vicinity of the electric vehicle are not taken into account in the calculation of the probability of being charged from the first power supply network. This affords the advantage of a particularly simple calculation.

In one configuration, the (total) probability P (F) that an electric vehicle F is connected to a (any) charging station Lᵢ from a group of n=1, 2, 3, 4, . . . possible charging stations Lᵢ of the first power supply network in the vicinity of the electric vehicle F is calculated in accordance with

$$P ( F ) = 1 - {\prod }_{i = 1}^{n} ( 1 - P ( {L}_{í} , {d}_{i} ) )$$

where P (Lᵢ, dᵢ) is the probability of the electric vehicle being connected to the charging station Lᵢ which is located at a distance dᵢ from the electric vehicle F. This calculation variant affords the advantage that the probability P (F) increases with each possible charging station Lᵢ in the vicinity, but the value P (F)=1 or 100% is not reached or exceeded. If only a single charging station L is located in the vicinity, and n=1 thus holds true, this results directly in P (F)=P (L, d), i.e., the resistance value is valid for this distance d.

This probability P (F) can be used to classify whether or not the electric vehicle F is to be assigned to the first power supply network.

In this regard, in one development, only electric vehicles for which P (F)>0.5 or P (F)≥0.5 holds true are or can be assigned to the first power supply network.

If a plurality of electric vehicles can be connected to a specific charging station, in one development, the fleet operator decides that the electric vehicle with the highest probability is classified as being connected to this charging station.

If a electric vehicles can be connected to b charging stations of the same power supply network, where a>b, in one development, the fleet operator decides that the b electric vehicles with the highest probabilities are classified as being connected to these charging stations or to this power supply network.

In one configuration, the probability P(F) that an electric vehicle F is connected to a (any) charging station Lᵢ from a group of possible charging stations Lᵢ of the first power supply network in the vicinity of the electric vehicle F is calculated in a way that additionally takes account of m=1, 2, 3, 4, . . . charging stations Nᵢ of a second power supply network adjacent thereto in the vicinity of the electric vehicle F. This achieves the advantage that the probability P(F) is determinable even more accurately.

In this case, the calculation can be configured such that the probability P(F) of connection to a charging station Lᵢ of the first power supply network decreases if there is the probability that the electric vehicle F could be connected to at least one charging station Nⱼ of the second power supply network.

In one configuration, the probability P(F) that a specific electric vehicle F is connected to a charging station Lᵢ from a group of charging stations L of the first power supply network in the vicinity of the electric vehicle F and is additionally located in the vicinity of a group of charging stations Nⱼ of a second power supply network is calculated in accordance with

$$P ( F ) = [ 1 - {\prod }_{i = 1}^{n} ( 1 - P ( {L}_{𝔦} , {d}_{i} ) ) ] \cdot {\prod }_{j = 1}^{m} ( 1 - P ( {N}_{j} , {d}_{j} ) )$$

where P (Lᵢ, dᵢ) is the probability of the electric vehicle F being connected to a respective charging station Lᵢ which is located at a distance dᵢ from the electric vehicle F, and P (Nⱼ, dⱼ) is the probability of the electric vehicle F being connected to a respective charging station Nⱼ which is located at a distance dⱼ from the electric vehicle F.

In one configuration, for the classification by the fleet operator as to whether or not a specific electric vehicle F is being charged from the first power supply network or is connected to a charging station Lᵢ of the first power supply network in the vicinity of the electric vehicle F, firstly the probability P₁ (F) of connection to charging stations Lᵢ located in the vicinity is calculated, without considering charging stations Nⱼ of the second power supply network in the vicinity of the electric vehicle F, i.e.

$${P}_{1} ( F ) = 1 - {\prod }_{i = 1}^{n} ( 1 - P ( {L}_{i} , {d}_{i} ) )$$

In addition, the probability P₂ (F) of connection to charging stations Nⱼ of the second power supply network that are located in the vicinity is calculated, without considering charging stations Lᵢ of the first power supply network in the vicinity of the electric vehicle F, i.e.

$${P}_{2} ( F ) = 1 - {\prod }_{j = 1}^{m} ( 1 - P ( {N}_{j} , {d}_{j} ) )$$

The electric vehicle F can be classified as being charged from the first power supply network, e.g., if P₁>P₂ holds true.

In one development, probabilities of association with different power supply networks can be associated with a specific charging station Lᵢ. This can be helpful for example for charging stations for which no network association data are available. In this case, the probability of an electric vehicle F being connected to a charging station Lᵢ can be calculated, e.g., in accordance with

$$P ( F ) = 1 - {\prod }_{i = 1}^{n} ( 1 - ( {P}^{′} ( {L}_{i} , {d}_{i} ) )$$

where P′ (Lᵢ, dᵢ)=P (Lᵢ, dᵢ)·φ*(Lᵢ)·(1−φ° (Li) is set, where Φ*(Lᵢ) indicates a probability that L belongs to the first power supply network and Φ*(Lᵢ) indicates a probability that the charging station Lᵢ belongs to the second power supply network. This can analogously be applied to other above calculations of the probability values.

In one development, the fleet operator can simulate a network behavior for chargings by a group of electric vehicles for which the constraints resulting from the received power request information are complied with, in particular a predefined maximum quantity of power able to be called up at the charging stations of the power supply network (“power buffer”). In this case, it is possible to vary quantities of power allocated to the charging stations or electric vehicles in the context of this simulation in order to satisfy the constraints with high probability. This variation can take account of charging properties of individual electric vehicles. The constraints can comprise for example the occurrence of specific operations or “events” that influence the power buffer, such that by means of the simulation, upon the occurrence of such operations, it is possible to assess how the network behavior changes and how it can be improved by changing the quantities of power allocated to the charging stations. Such events can comprise, e.g., the outage or the switching on of power generating units (power plants, solar installations, etc.), the outage of power lines, the increased or decreased power consumption of other consumers in the power supply network, etc. The simulations can be carried out for different groups of electric vehicles that differ e.g. in the number and/or type of electric vehicles under consideration. The simulations can be further improved by comparison with a real network behavior, including, if appropriate, the occurrence of specific events, with knowledge of the quantities of power retrieved at the charging stations.

The better the charging properties of the electric vehicles connected to the power supply network are known, the better the power supply network can react to an event on the basis of simulation results. This is the case particularly if electric vehicles that are connected to the charging stations only with a certain probability, for charging of their energy storage device, are preferred over such electric vehicles which are practically definitely connected to charging stations, e.g., on account of easier compliance with contractually agreed charging conditions, faster charging, a lifetime of the energy storage device, etc. Such electric vehicles can be taken into account, for example, with a weighting factor dependent on the probability of their connection to the charging station.

The object is also achieved by means of a charging control system configured to carry out the method described above. The charging system can be designed analogously to the method, and vice versa, and has the same advantages.

In one configuration, the charging control system has a data processing device configured to carry out the method described above. The charging control system can be operated by a fleet operator.

The charging control system can be configured, for example
to receive power request information from an operator of a first power supply network;
to identify electric vehicles currently being charged in the vicinity of the first power supply network or in the vicinity of the charging stations of the first power supply network on the basis of their positions;
to assign to electric vehicles that are not uniquely assignable to the first power supply network a probability that they are connected to the first power supply network or a charging station thereof;
to determine, on the basis of the probabilities, which of these electric vehicles are classified as being connected to a charging station of the first power supply network,
to select a charging strategy derived from the simulations described above, for example, for the electric vehicles being charged from the first power supply network, which charging strategy accommodates the power request information, in particular fulfils the latter,
to remotely instruct the electric vehicles being charged to adapt or to vary their charging operations in accordance with the selected charging strategy and thus also on the basis of the received power request information.

The object is also achieved by means of a computer program product comprising code which, when it is executed on a data processing device, in particular of the charging control system, carries out the method described above.

The above-described properties, features and advantages of this invention and the way in which they are achieved will become clearer and more clearly understood in association with the following schematic description of an exemplary embodiment which will be explained in greater detail in association with the drawing.

### BRIEF DESCRIPTION OF THE DRAWINGS

FIG. 1 shows a possible sequence for charging electric vehicles connected to charging stations of a power supply network; and

FIG. 2 shows a plot of probability values for connection of two different electric vehicles to a specific charging station against a respective distance from the charging station.

### DETAILED DESCRIPTION OF THE DRAWINGS

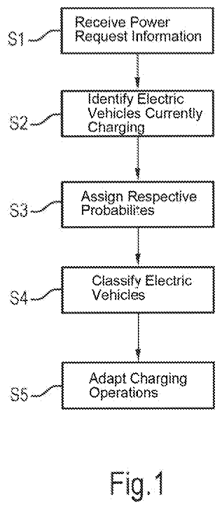

FIG. 1 shows a possible sequence for adapting charging operations of electric vehicles on the part of a fleet operator of these electric vehicles.

In a first step S1, the fleet operator receives power request information from an operator of a first power supply network, e.g., the fact that owing to a certain event the charging power available hitherto for the electric vehicles of the fleet operator is or will be reduced for a short period. Alternatively, there could be, e.g., notification of the fact that more charging power is now available.

The fleet operator then attempts to establish which electric vehicles in the operator's fleet are currently being charged from the first power supply network. They uniquely include all electric vehicles which are in a 1-to-1 relationship with a charging station of the first power supply network and all electric vehicles which are uniquely located within the geographical extent or area of the first power supply network. One or both conditions may be applicable to a vehicle.

The fleet operator additionally attempts to take account of electric vehicles which are being charged from the first power supply network possibly or only with a certain probability. For this purpose, in a step S2, the fleet operator identifies electric vehicles in the fleet which are currently being charged and which are located in the vicinity of the first power supply network and are not uniquely assigned to a charging station, i.e. could be connected to the first power supply network, without the fleet operator being able to unambiguously establish this.

In a step S3, the fleet operator assigns to the electric vehicles identified in step S2 respective probabilities that they are being charged from the first power supply network, e.g. by virtue of their being connected to a charging station of the first power supply network.

In a step S4, the fleet operator classifies each of the electric vehicles considered in steps S2 and S3, on the basis of the associated probabilities, as being charged from the first power supply network or not being charged from the first power supply network.

In a step S5, the charging operations of the electric vehicles uniquely associated with the first power supply network and also the charging operations of the electric vehicles classified as being charged from the first power supply network in step S4 are adapted on the basis of the received power request information, e.g., in accordance with a charging strategy which was obtained from simulations in the context of power supply management and is best coordinated with the constraints of the first power supply network that are determined by the power request information.

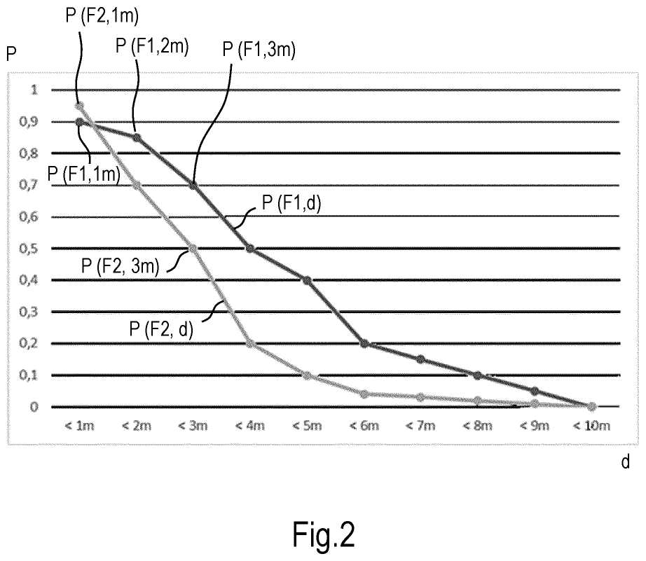

FIG. 2 shows a plot of purely exemplary curves of probabilities or probability values P (F1, d) and P (F2, d) for connection of remotely identifiable electric vehicles F1 and F2, respectively, with different position determining devices or locating technologies to a charging station against an established distance d from the charging station. These probability curves can be used e.g. to assign respective probabilities P (F1), P (F2) to the electric vehicles F1, F2 in accordance with step S3.

In one development, the probability values P (F1, d) and P (F2, d) can be retrieved from the electric vehicles F1, F2, respectively, or can alternatively be retrieved from a database after the VINs of the electric vehicles have been determined. In one development, the probability values P (F1, d) and P (F2, d) can be different for different charging stations for the same electric vehicles F1, F2, e.g. for charging stations on other streets or at other districts, since there the positions of the electric vehicles F1, F2 and/or the positions of the charging stations may be determinable more accurately or less accurately.

If, by way of example, the electric vehicle F1 is measured and found to be located within a distance of 1 m from the charging station (corresponding to d<1 m or d≤1 m), the electric vehicle F1 is assigned the probability value P (F1, d)=P (F1, 1 m)=0.9. Analogously, for the distances d<2 m, 3 m, 4 m, 5 m, etc., the electric vehicle F1 is assigned the probability values 0.85, 0.8, 0.7, 0.5 or 0.4, respectively. The electric vehicle F2 is assigned corresponding probability values P (F2, d).

In one scenario, it shall be assumed that the two electric vehicles F1 and F2 are located in the vicinity of a single charging station, for example at the same measured or determined distance of d<3 m. Therefore, in step S3, the electric vehicle F1 is assigned a probability value P (F1) corresponding to the probability value P (F1, 3 m)=0.7, and the electric vehicle F2 is assigned a probability P (F2) corresponding to the probability value P (F2, 3 m)=0.5.

Since the probability P (F1) for electric vehicle F1 is thus higher than the probability P (F2) for electric vehicle F2, electric vehicle F1 is preferred and, consequently, in step S4 the classification is made that electric vehicle F1 is connected to the charging station, whereas electric vehicle F2 is not.

Therefore, only the charging operation of electric vehicle F1 is adapted by the fleet operator in step S5.

In one variant, the method or a corresponding charging system can be designed so as to take account of further charging stations in the vicinity of the electric vehicles F1 and F2 (here, e.g., within a radius of 10 m) which likewise belong to the first power supply network under consideration.

The cumulated probability P that an electric vehicle is connected to a charging station from a group of, e.g., two charging stations (designated here as L₁ and L₂) can then be calculated as P=1−(1−P(L₁, d₁))·(1<P(L₂, d₂)), where d₁ denotes the distance from the charging station L₁ and d₂ denotes the distance from the charging station L₂. By way of example, if electric vehicle F1 is located at a distance d₁=3 m from the charging station L₁ and at a distance d₂=4 m from the charging station L₂, the probability P (F1) that the electric vehicle F1 is connected to (any) one of the two charging stations L₁, L₂ can be calculated as P (F1)=1−(1−P(L₁, d₁))·(1−P(L₂, d₂))=1−(1−0.7)·(1−0.5)=1−0.3·0.5=0.85.

This is likewise higher than the probability P (F2) of 0.5 if the electric vehicle F2 is still only located in the vicinity of a single charging station. It would thus still be assumed that electric vehicle F1 is connected to one of the charging stations L₁, L₂, and electric vehicle F2 is not. In this calculation, the probability for a specific electric vehicle increases with the number of possible connected charging stations.

This scheme for calculating the (total) probability P (F) of connection to the first power supply network can be analogously extended for a specific electric vehicle F to any desired number of charging stations Lᵢ where i=1, . . . , n and their individual probabilities P (Lᵢ, dᵢ) dependent on the distances dᵢ in accordance with

$$P ( F ) = 1 - {\prod }_{i = 1}^{n} ( 1 - P ( {L}_{i} , {d}_{i} ) )$$

Charging stations of a second, neighboring power supply network are not taken into account in the above calculations of the probabilities. That makes the calculations particularly simple and fast and also enables a consistent calculation if the charging stations of the second power supply network are not known to the fleet operator.

However, the probabilities can also be calculated taking into account charging stations Nⱼ where j=1, . . . , m of the second power supply network. This is particularly advantageous if the second power supply network is intended as far as possible not to be influenced by charging operations of electric vehicles incorrectly classified as being charged from the first power supply network. In this respect, charging stations of the second power supply network shall be designated as N₃, N₄, . . . in the following development of the above example. It shall now be assumed that electric vehicle F1 is additionally located at a distance d₃<2 m from the charging station N₃ and at a distance d₄<3 m from the charging station N₄. Furthermore, it shall be assumed that electric vehicle F2 is at a distance d₃<10 in from charging station N₃. For each of the two electric vehicles F1 and F2, it is then possible to calculate a (total) probability or indication in accordance with

P(F1)=[1−(1−P(L₁,d₁))*(1−P(L₂,d₂))]*(1−P(N₃,d₃))*(1−P(N₄,d₄))=0.85*(1−0.85)*(1−0.7)=0.85*0.15*0.3=0.03825

and

P(F2)=0.5·(1−P(N₃,d₃))=0.5·(1−0)=0.5,

which in the present example helps to decide in favor of the electric vehicle F2 since P(F2)>P(F1). The probability P (F1) that electric vehicle F1 is connected to the first power supply network thus decreases because it could also be connected to charging stations of the second power supply network.

Such a probability P (F) can be calculated for charging stations Nⱼ where j=1, . . . , m generally as:

$$P ( F ) = [ 1 - {\prod }_{i = 1}^{n} ( 1 - P ( {L}_{i} , {d}_{i} ) ) ] \cdot {\prod }_{j = 1}^{m} ( 1 - P ( {N}_{j} , {d}_{j} )$$

Generally, therefore, in this calculation the probabilities of a specific electric vehicle F being connected to a charging station of a power supply network are reduced if this electric vehicle could also be connected to charging stations of another power supply network.

Furthermore, probability values can be associated with a specific charging station, these probability values providing information about the probability with which these are connected with different power supply networks. This can be helpful, for example, for charging stations for which no network association data are available. In this case, the probability of an electric vehicle F being connected to a charging station Lᵢ can be calculated, e.g., in accordance with

$$P ( F ) = 1 - {\prod }_{i = 1}^{n} ( 1 - ( {P}^{′} ( {L}_{i} , {d}_{i} ) )$$

where P′ (Lᵢ, dᵢ)=P (Lᵢ, dᵢ)·φ*(Lᵢ)·(1−φ° (Li) is set, where Φ*(Lᵢ) indicates a probability that Lᵢ belongs to a first power supply network or charging network, while Φ° (Lᵢ) indicates a probability that the charging station Lᵢ belongs to a second power supply network or charging network.

It goes without saying that the present invention is not restricted to the exemplary embodiment shown.

Generally, “a(n)”, “one”, etc. can be understood to mean a singular or a plural, in particular in the sense of“at least one” or “one or more”, etc., as long as this is not explicitly excluded, e.g., by the expression “exactly one”, etc.

### LIST OF REFERENCE SIGNS

d Distance
S1-S5 Method steps
P Probability
P (F1) Probability curve for electric vehicle F1
P (F2) Probability curve for electric vehicle F2
P (F1, d) Probability value for electric vehicle F1 at the distance d from a charging station
P (F2, d) Probability value for electric vehicle F2 at the distance d from a charging station

1.-10. (canceled)

11. A method for adapting charging operations of electric vehicles for a fleet operator of a fleet of electric vehicles, the method comprising:
receiving power request information from an operator of a first power supply network;
assigning to electric vehicles of the fleet, which are currently being charged and which are located in a vicinity of the first power supply network and are not uniquely assigned to a charging station, a probability of being charged from the first power supply network;
classifying, based on the probability, the electric vehicles as being charged from the first power supply network or not being charged from the first power supply network; and
adapting the charging operations of the electric vehicles classified as being charged from the first power supply network based on the received power request information.

12. The method according to claim 11, wherein each electric vehicle is assigned a probability values of being connected to a specific charging station of the first power supply network, the probability value being dependent on at least a distance between the electric vehicle and the specific charging station.

13. The method according to claim 12, wherein the probability value increases as the distance between the electric vehicle and the specific charging station decreases.

14. The method according to claim 12, wherein the probability value is dependent on a position determining device and/or locating technology used by the electric vehicle.

15. The method according to claim 13, wherein the probability value is dependent on a position determining device and/or locating technology used by the electric vehicle.

16. The method according to claim 12, wherein the probability value is dependent on an accuracy of knowledge of a position of the specific charging station.

17. The method according to claim 13, wherein the probability value is dependent on an accuracy of knowledge of a position of the specific charging station.

18. The method according to claim 14, wherein the probability value is dependent on an accuracy of knowledge of a position of the specific charging station.

19. The method according to claim 12, wherein the probability that the electric vehicle is connected to the specific charging station of the first power supply network is dependent on a number of charging stations of the first power supply network which are located in a vicinity of the electric vehicle.

20. The method according to claim 13, wherein the probability that the electric vehicle is connected to the specific charging station of the first power supply network is dependent on a number of charging stations of the first power supply network which are located in a vicinity of the electric vehicle.

21. The method according to claim 14, wherein the probability that the electric vehicle is connected to the specific charging station of the first power supply network is dependent on a number of charging stations of the first power supply network which are located in a vicinity of the electric vehicle.

22. The method according to claim 15, wherein the probability that the electric vehicle is connected to the specific charging station of the first power supply network is dependent on a number of charging stations of the first power supply network which are located in a vicinity of the electric vehicle.

23. The method according to claim 19, wherein the probability that the electric vehicle is connected to the specific charging station from a group of charging stations of the first power supply network in a vicinity of the electric vehicle is calculated in accordance with
$$P ( F ) = 1 - {\prod }_{i = 1}^{n} ( 1 - P ( {L}_{ì} , {d}_{i} ) )$$
where P (Lᵢ, dᵢ) is a probability of the electric vehicle being connected to a respective charging station Lᵢ which is located at a distance dᵢ from the electric vehicle.

24. The method according to claim 19, wherein the probability that a specific electric vehicle is connected to the specific charging station from a group of charging stations of the first power supply network in a vicinity of the electric vehicle and is additionally located in a vicinity of a group of charging stations of a second power supply network is calculated in accordance with
$$P ( F ) = [ 1 - {\prod }_{i = 1}^{n} ( 1 - P ( {L}_{𝔦} , {d}_{i} ) ) ] \cdot {\prod }_{j = 1}^{m} ( 1 - P ( {N}_{j} , {d}_{j} ) )$$
where P (Lᵢ, dᵢ) is a probability of the electric vehicle being connected to a respective charging station Lᵢ which is located at a distance dᵢ from the electric vehicle, and P (Nⱼ, dⱼ) is a probability of the electric vehicle being connected to a respective charging station Nⱼ which is located at a distance dⱼ from the electric vehicle.

25. A charging control system configured to carry out the method according to claim 11.

26. A computer program product comprising code which, when executed on a data processing device, carries out a method according to claim 11.
